(19) United States
(12) Patent Application Publication
(10) Pub. No.: US 2026/0039036 A1
(43) Pub. Date: Feb. 5, 2026

(54) TERMINAL BLOCK STRUCTURE AND CONNECTING TERMINAL MODULE THEREOF

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/792,692

(22) Filed: Aug. 2, 2024

(51) Int. Cl. H01R 9/24

(52) U.S. Cl. CPC H01R 9/2416

(57) ABSTRACT

A terminal block structure (10) includes an insulative base (1) and a connecting terminal module (2). The insulative base (1) has a chamber (11) therein and is extended with two fixing blocks (12). Two wiring troughs (14) are disposed thereon. The connecting terminal module (2) is accommodated in the chamber (11) and includes a fixed terminal (21) and two operatable terminals (22). The fixed terminal (21) has a transverse sheet (211) and two upright sheets (212). The two upright sheets (212) are outward bent with two elastic support arms (213) abutting against the two fixing blocks (12). Each operatable terminal (22) abuts against each elastic support arm (213) and each fixing block (12). An outer end of each operatable terminal (22) is extended with an operatable sheet (223) blocking between each wiring trough (14) and the chamber (11). An inner end is extended with a stopping sheet (222).

### BACKGROUND

### Technical Field

The disclosure relates to a terminal structure, particularly to a terminal block structure and a connecting terminal module thereof.

### Related Art

A terminal block is a common connecting component which has been widely applied to industrial communication with huge data and close integration between devices to improve electric power industry of reliability and safety of power systems and industrial control with higher automation.

A related art terminal block structure includes a plastic frame and a connecting terminal module installed to the plastic frame. The connecting terminal module includes an upper elastic sheet and a lower elastic sheet, which are fixed on two sides of the plastic frame. An end of the upper elastic sheet has a free end abutting against the lower elastic sheet. When a wire or a cable is inserted in between the free end of the upper elastic sheet and the lower elastic sheet, the free end of the upper elastic sheet can return toward the lower elastic sheet to make the wire or cable clamped between the free end of the upper elastic sheet and the lower elastic sheet to accomplish an electric connection between a wire or cable and both the upper elastic sheet and the lower elastic sheet.

However, it is usually seen that a flat object such as a screwdriver is inserted in between the upper elastic sheet and the plastic frame or an additional tongue movably or rotatably abuts against the upper elastic sheet to force the free end of the upper elastic sheet to go away from the lower elastic sheet. However, because plastic is weaker than metal in support strength, the upper elastic sheet is easy to move downward to escape from the installed position of the plastic frame, which causes that the friction between the upper elastic sheet and the plastic frame increases to affect wiring speed and operation of the terminal block when pressing the upper elastic sheet next time.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

The disclosure provides a terminal block structure and a connecting terminal module thereof, which use the operatable terminal to abut against the elastic support arm of the fixed terminal to make the operatable terminal still stay at the original position without deflection after long-term use to accomplish the advantages of the terminal block structure and the connecting terminal module having long-term stable wiring speed and operation.

In embodiments of the disclosure, the disclosure provides a terminal block structure, which includes: an insulative base, having a chamber therein, extended with two fixing blocks in the chamber, and two wiring troughs communicating with the chamber being disposed thereon; and a connecting terminal module, accommodated in the chamber, and including: a fixed terminal, comprising a transverse sheet disposed correspondingly to a bottom edge of each wiring trough and two upright sheets upward extended from two ends of the transverse sheet, and the two upright sheets being outward bent with two elastic support arms abutting against the two fixing blocks; and two operatable terminals, abutting against the two elastic support arms and the two fixing blocks, an outer end of each operatable terminal being extended with an operatable sheet disposed outside each upright sheet and blocking between each wiring trough and the chamber, and an inner end being extended with a stopping sheet disposed correspondingly to each operatable sheet.

In embodiments of the disclosure, the disclosure provides a connecting terminal module, which includes: a fixed terminal, having a transverse sheet and two upright sheets upward extended from two ends of the transverse sheet, and the two upright sheets being outward bent with two elastic support arms; and two operatable terminals, abutting against the two elastic support arms, an outer end of each operatable terminal being extended with an operatable sheet disposed outside each upright sheet, and an inner end being extended with a stopping sheet disposed correspondingly to each operatable sheet.

As a result, the operatable terminal abuts against the elastic support arm of the fixed terminal. Because the metal material of the elastic support arm has better structural strength than the plastic material, when the operatable sheet is pushed inward, the operatable terminal pressurizes the elastic support arm, but the strength of the elastic support arm has been enhanced, so the operatable terminal is hard to be rotated to deflect from the original position so as to make the operatable terminal still stay at the original position without deflection after long-term use to accomplish the advantages of the terminal block structure and the connecting terminal module having long-term stable wiring speed and operation.

### BRIEF DESCRIPTION OF THE DRAWINGS

FIG. 1 is an exploded view of the connecting terminal module of the disclosure;

FIG. 2 is an exploded view of the terminal block structure of the disclosure;

FIG. 3 is an assembled perspective view of the terminal block structure of the disclosure;

FIG. 4 is a cross-sectional view of the terminal block structure of the disclosure;

FIG. 5 is a schematic view of using status of the terminal block structure of the disclosure;

FIG. 6 is another schematic view of using status of the terminal block structure of the disclosure;

FIG. 7 is still another schematic view of using status of the terminal block structure of the disclosure; and

FIG. 8 is yet another schematic view of using status of the terminal block structure of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

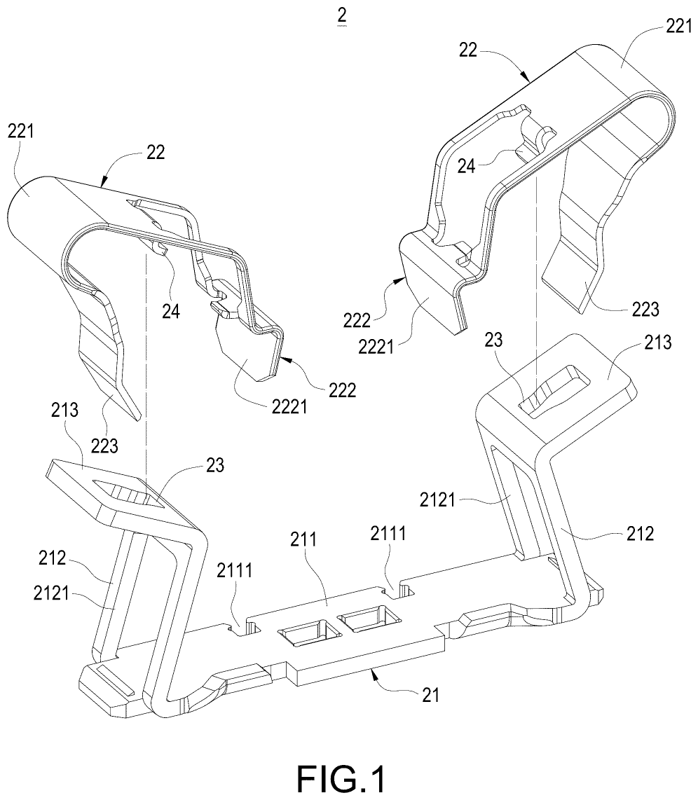

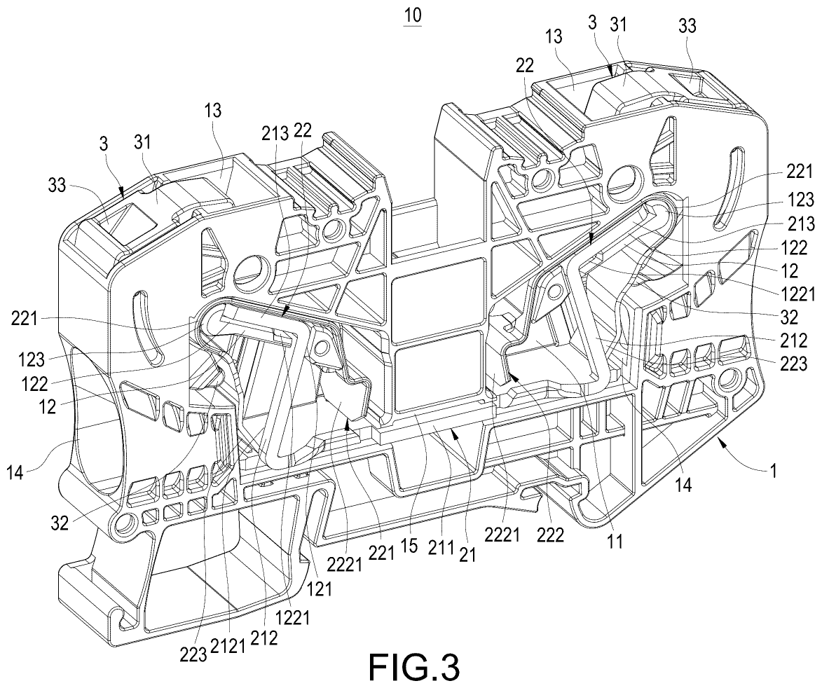

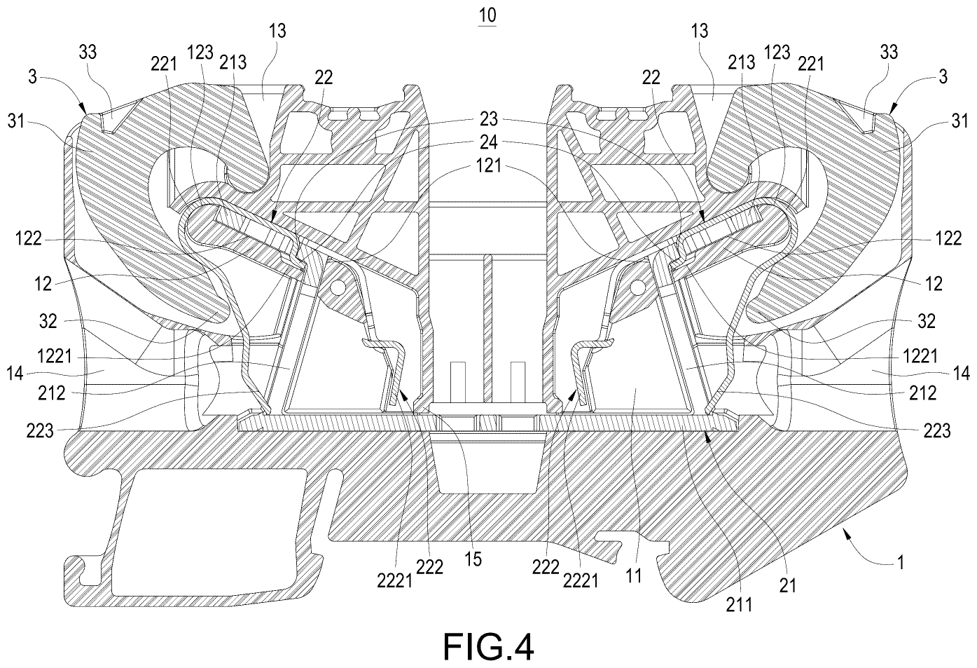

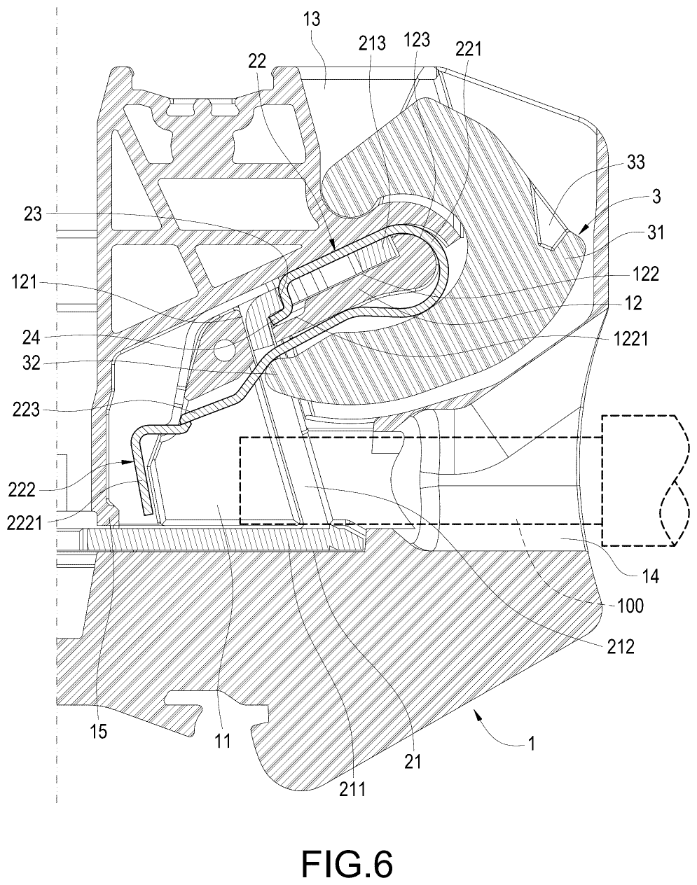

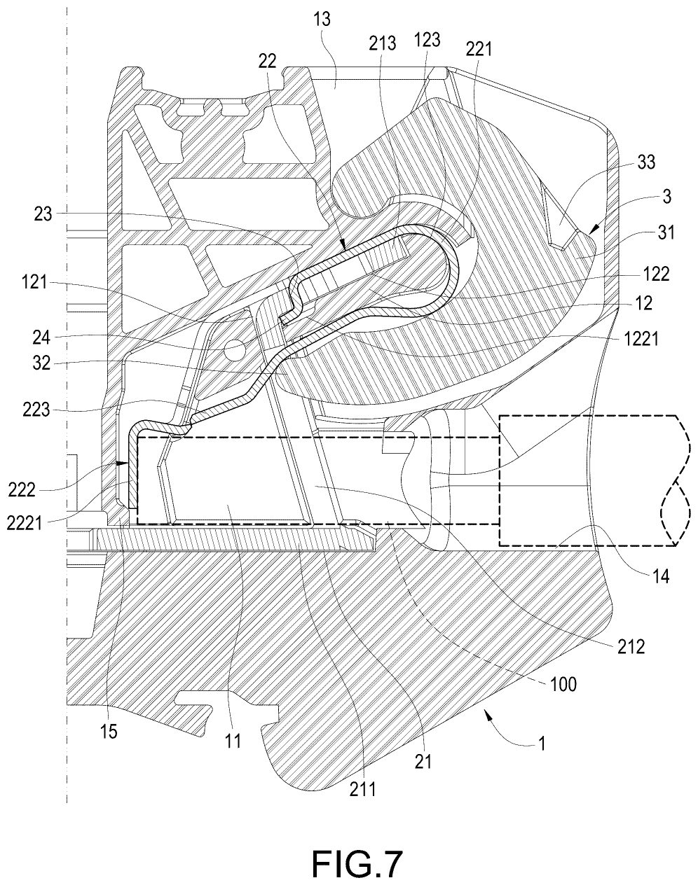

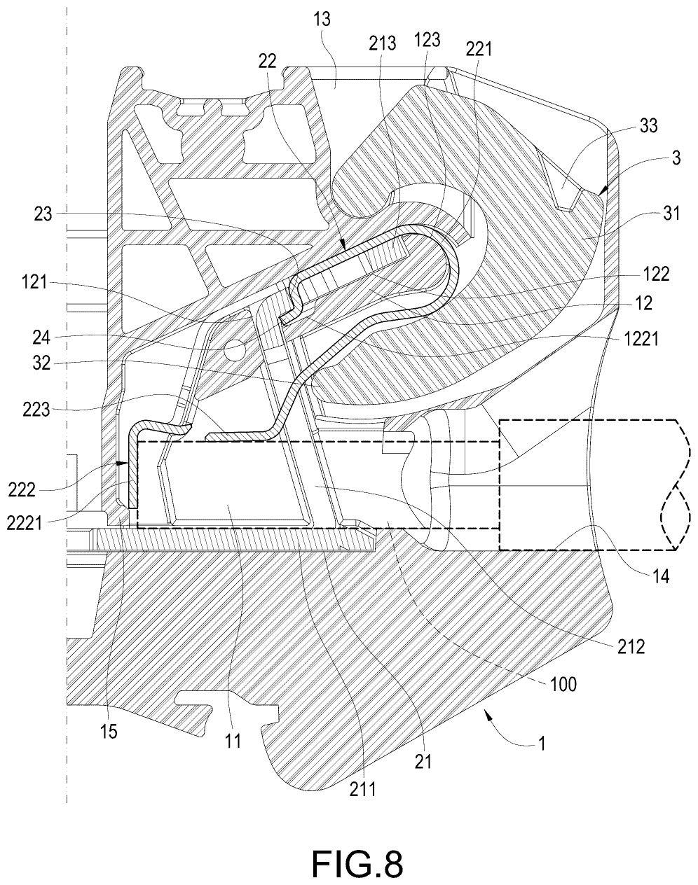

Please refer to FIGS. 1-8. The disclosure provides a terminal block structure and a connecting terminal module thereof. The terminal structure 10 mainly includes an insulative base 1 and a connecting terminal module 2. The connecting terminal module 2 mainly includes a fixed terminal 21 and two operatable terminals 22.

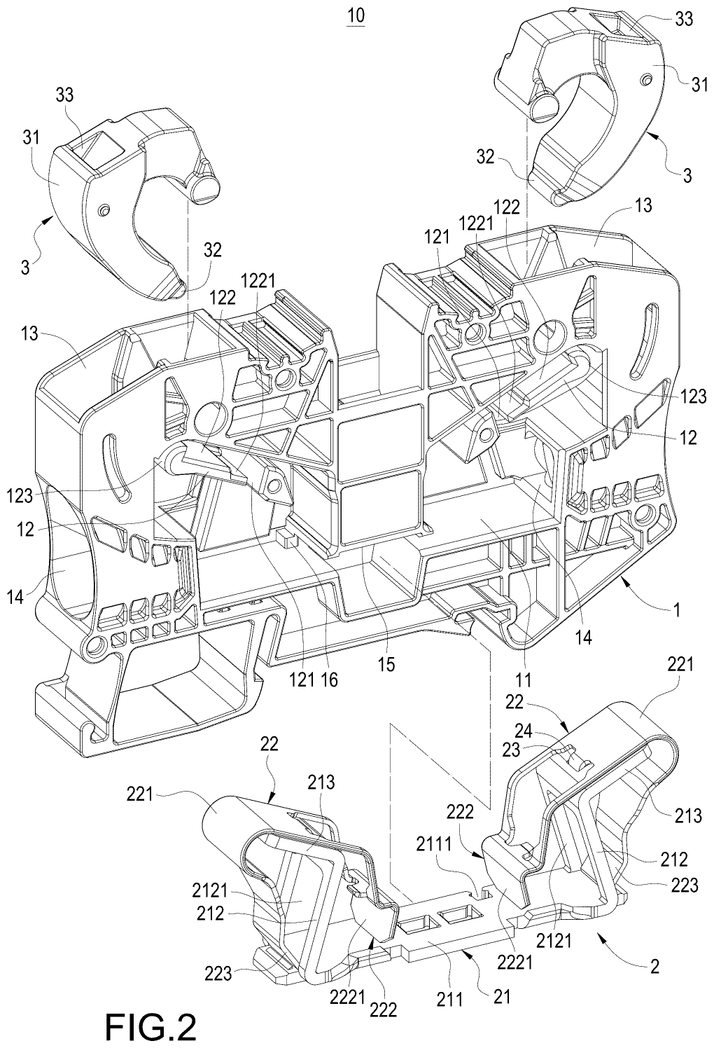

As shown in FIGS. 2-8, the insulative base 1 is composed of plastic material. The insulative base 1 has a chamber 11 therein, is extended with two fixing blocks 12 in the chamber 11, and both two communicating troughs 13 and two wiring troughs 14, which communicate with the chamber 11, are disposed thereon. The two communicating troughs 13 are disposed above the chamber 11. The two wiring troughs 14 are disposed on two lateral sides of the chamber 11.

In detail, the top side of each fixing block 12 is disposed with a through hole 121 and a dented groove 122 and one end has an arcuate end 123. The bottom wall of each dented groove 122 is disposed with a dented hole 1221. Each dented hole 1221 communicates with each through hole 121. Outlines of the two fixing blocks 12 are laterally symmetric. The inside of the insulative base 1 is further extended with a lower rod 15 and multiple protrusions 16 in the chamber 11.

As shown in FIGS. 1-8, the connecting terminal module 2 is accommodated in the chamber 11 and includes a fixed terminal 21 and two operatable terminals 22. The fixed terminal 21 and the operatable terminals 22 are composed of conductive metal material. The fixed terminal 21 is greater than each operatable terminal 22 in thickness.

In detail, the fixed terminal 21 has a transverse sheet 211 disposed correspondingly to a bottom edge of each wiring trough 14 and two upright sheets 212 upward extended from two ends of the transverse sheet 211. The middle section of the transverse sheet 211 is stopped by the lower rod 15. The transverse sheet 211 is disposed with multiple notches 2111. Each protrusion 16 engages with each notch 2111 to make the transverse sheet 211 firmly positioned in the chamber 11. The two upright sheets 212 are outward bent with two elastic support arms 213. Each upright sheet 212 passes through each through hole 121. Each elastic support arm 213 is embedded into each dented groove 122 to make the two elastic support arms 213 abut against the two fixing blocks 12.

In addition, each operatable terminal 22 has a U-shaped bent sheet 221. The middle of each U-shaped bent sheet 221 abuts against each arcuate end 123 and the inner side abuts against each elastic support arm 213 to make the two operatable terminals 22 firmly abut against the two elastic support arms 213 and the two fixing blocks 12. An outer end of each operatable terminal 22 is extended with an operatable sheet 223 disposed outside each upright sheet 212 and blocking between each wiring trough 14 and the chamber 11, and an inner end is extended with a stopping sheet 222 disposed correspondingly to each operatable sheet 223. Each stopping sheet 222 and each operatable sheet 223 are separately extended from two ends of each U-shaped bent sheet 221.

Furthermore, each elastic support arm 213 is disposed with an engaging groove 23. Each operatable terminal 22 is extended with a latch 24. Each latch 24 engages with each engaging groove 23 and is embedded into each dented hole 1221. A distal end of each latch 24 stretches into each through hole 121 and abuts against the inner side of the joint of each upright sheet 212 and each elastic support arm 213.

Also, each upright sheet 212 is disposed with a hollow opening 2121 disposed correspondingly to each wiring trough 14. Each operatable sheet 223 can penetrate into each hollow opening 2121. A distal end of each stopping sheet 222 is bent with an inverted L-shaped blocking portion 2221. Each inverted L-shaped blocking portion 2221 is used for blocking a distal end of a wire material 100 such as a wire or cable.

Besides, shapes of each upright sheet 212 and each elastic support arm 213, which are integrally extended to be formed, appear to be a vee shape, and a shape of each operatable terminal 22 appears to be an inverted vee shape to make the fixed terminal 21 and the two operatable terminals 22, which abut against each other, jointly form a butterfly-shaped frame.

As shown in FIGS. 2-8, the terminal structure 10 of the disclosure further includes two inward pushing handles 3 accommodated in each communicating trough 13. An end of each inward pushing handle 3 is pivoted to the insulative base 1 and the other end abuts against each operatable sheet 223.

In detail, each inward pushing handle 3 is a U-shaped handle 31. An end of each U-shaped handle 31 is pivoted to the insulative base 1 and disposed above each U-shaped bent sheet 221, the other end has a moving end 32 abutting against each operatable sheet 223 and the middle is disposed with a pushing indent 33 exposed in each communicating trough 13. Inserting a flat object (not shown) such as a screwdriver into the pushing indent 33 may drive the U-shaped handle 31 to rotate so as to make the moving end 32 push the operatable sheet 223 to move toward the wiring trough 14.

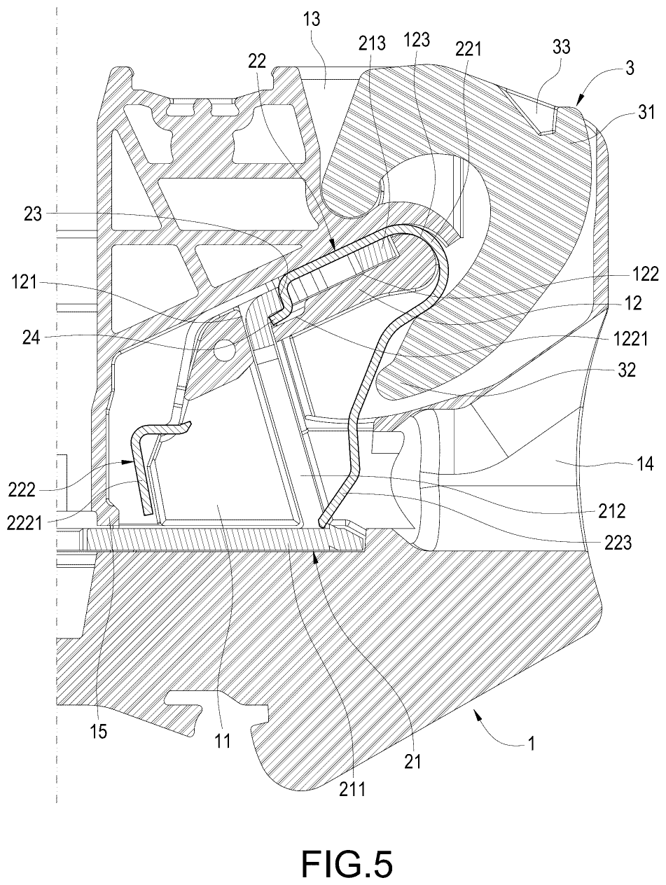

As shown in FIGS. 5-8, which show using statuses of the terminal block structure 10 and the connecting terminal module 2 of the disclosure, it uses a flat object such as a screwdriver inserted into the pushing indent 33 to drive the inward pushing handle 3 to rotate so as to drive the moving end 32 to push the operatable sheet 223 to move toward the wiring trough 14. After that, a wire material 100 such as a wire or cable is inserted into the wiring trough 14 until being blocked by the stopping sheet 222, and then the inward pushing handle 3 may be released to make the operatable sheet 223 return toward the position blocking between each wiring trough 14 and the chamber 11. Finally, the wire material 100 such as a wire or cable is clamped between the transverse sheet 211 and the operatable sheet 223. That is, the wire material 100 such as a wire or cable is clamped between the fixed terminal 21 and the operatable terminal 22 to finish the wiring operation of the terminal block structure 10.

In addition, the operatable terminal 22 of the disclosure abuts against the arcuate end 123 of the insulative base 1 and the elastic support arm 213 of the fixed terminal 21. Because the metal material of the elastic support arm 213 has better structural strength than the plastic material of the arcuate end 123, when the operatable sheet 223 is pushed toward the wiring trough 14 by the inward pushing handle 3, the U-shaped bent sheet 221 of the operatable terminal 22 pressurizes the arcuate end 123 and the elastic support arm 213, but the strength of the elastic support arm 213 has been enhanced, so the U-shaped bent sheet 221 of the operatable terminal 22 is hard to be rotated to deflect from the original position and the contact area of the U-shaped bent sheet 221 and the fixing block 12 can be reduced so as to reduce the friction between different materials to effectively reduce the rotating force of the U-shaped bent sheet 221. This makes the operatable terminal 22 still stay at the original position without deflection after long-term use to accomplish the advantages of the terminal block structure 10 and the connecting terminal module 2 having long-term stable wiring speed and operation.

In addition, the elastic support arm 213 is disposed with the engaging groove 23, the operatable terminal 22 is extended with the latch 24, the latch 24 engages with the engaging groove 23, and a distal end of the latch 24 abuts against the inner side of the joint of the upright sheet 212 and the elastic support arm 213, so that the operatable terminal 22 and the fixed terminal 21 abut against each other more firmly to increase the function of the operatable terminal 22 still staying at the original position without deflection after long-term use.

While this disclosure has been described by means of specific embodiments, numerous modifications and variations could be made thereto by those skilled in the art without departing from the scope and spirit of this disclosure set forth in the claims.

What is claimed is:

1. A terminal block structure comprising:
an insulative base (1), comprising a chamber (11) therein, extended with two fixing blocks (12) in the chamber (11), and two wiring troughs (14) communicating with the chamber (11) being disposed thereon; and
a connecting terminal module (2), accommodated in the chamber (11), and comprising:
a fixed terminal (21), comprising a transverse sheet (211) disposed correspondingly to a bottom edge of each wiring trough (14) and two upright sheets (212) upward extended from two ends of the transverse sheet (211), and the two upright sheets (212) being outward bent with two elastic support arms (213) abutting against the two fixing blocks (12); and
two operatable terminals (22), abutting against the two elastic support arms (213) and the two fixing blocks (12), an outer end of each operatable terminal (22) being extended with an operatable sheet (223) disposed outside each upright sheet (212) and blocking between each wiring trough (14) and the chamber (11), and an inner end being extended with a stopping sheet (222) disposed correspondingly to each operatable sheet (223).

2. The terminal block structure of claim 1, wherein a top side of each fixing block (12) is disposed with a through hole (121) and a dented groove (122), which communicate with each other, and one end comprises an arcuate end (123), each upright sheet (212) passes through each through hole (121), each elastic support arm (213) is embedded into each dented groove (122), each operatable terminal (22) comprises a U-shaped bent sheet (221), a middle of each U-shaped bent sheet (221) abuts against each arcuate end (123) and an inner side abuts against each elastic support arm (213), and each stopping sheet (222) and each operatable sheet (223) are separately extended from two ends of each U-shaped bent sheet (221).

3. The terminal block structure of claim 2, wherein a bottom wall of each dented groove (122) is disposed with a dented hole (1221), the fixed terminal (21) is greater than each operatable terminal (22) in thickness, each elastic support arm (213) is disposed with an engaging groove (23), and each operatable terminal (22) is extended with a latch (24), each latch (24) engages with each engaging groove (23) and is embedded into each dented hole (1221).

4. The terminal block structure of claim 3, wherein each dented hole (1221) communicates with each through hole (121), a distal end of each latch (24) stretches into each through hole (121) and abuts against an inner side of a joint of each upright sheet (212) and each elastic support arm (213).

5. The terminal block structure of claim 2, further comprising two inward pushing handles (3), wherein two communicating troughs (13) communicating with the chamber (11) are disposed on the insulative base (1), each inward pushing handle (3) is accommodated in each communicating trough (13), and an end of each inward pushing handle (3) is pivoted to the insulative base (1) and another end abuts against each operatable sheet (223).

6. The terminal block structure of claim 5, wherein each inward pushing handle (3) is a U-shaped handle (31), an end of each U-shaped handle (31) is pivoted to the insulative base (1) and disposed above each U-shaped bent sheet (221), another end comprises a moving end (32) abutting against each operatable sheet (223), and a middle is disposed with a pushing indent (33) exposed in each communicating trough (13).

7. The terminal block structure of claim 1, wherein each upright sheet (212) is disposed with a hollow opening (2121) disposed correspondingly to each wiring trough (14), each operatable sheet (223) can penetrate into each hollow opening (2121), and a distal end of each stopping sheet (222) is bent with an inverted L-shaped blocking portion (2221).

8. The terminal block structure of claim 1, wherein an inside of the insulative base (1) is further extended with a lower rod (15) and multiple protrusions (16) in the chamber (11), a middle section of the transverse sheet (211) is stopped by the lower rod (15), the transverse sheet (211) is disposed with multiple notches (2111), and each protrusion (16) engages with each notch (2111).

9. A connecting terminal module comprising:
a fixed terminal (21), comprising a transverse sheet (211) and two upright sheets (212) upward extended from two ends of the transverse sheet (211), and the two upright sheets (212) being outward bent with two elastic support arms (213); and
two operatable terminals (22), abutting against the two elastic support arms (213), an outer end of each operatable terminal (22) being extended with an operatable sheet (223) disposed outside each upright sheet (212), and an inner end being extended with a stopping sheet (222) disposed correspondingly to each operatable sheet (223).

10. The connecting terminal module of claim 9, wherein each fixed terminal (21) is greater than each operatable terminal (22) in thickness, each elastic support arm (213) is disposed with an engaging groove (23), each operatable terminal (22) is extended with a latch (24), and each latch (24) engages with each engaging groove (23).

11. The connecting terminal module of claim 9, wherein each upright sheet (212) is disposed with a hollow opening (2121), each operatable sheet (223) penetrates into each hollow opening (2121), and a distal end of each stopping sheet (222) is bent with an inverted L-shaped blocking portion (2221).
